(19) United States
(12) Patent Application Publication
(10) Pub. No.: US 2021/0327641 A1
(43) Pub. Date: Oct. 21, 2021

(54) COIL COMPONENT

(71) Applicant: TDK CORPORATION, Tokyo (JP)

(72) Inventors: Hokuto EDA, Tokyo (JP); Masataro SAITO, Tokyo (JP); Kohei TAKAHASHI, Tokyo (JP); Takamasa IWASAKI, Tokyo (JP)

(73) Assignee: TDK CORPORATION, Tokyo (JP)

(21) Appl. No.: 17/233,790

(22) Filed: Apr. 19, 2021

(30) Foreign Application Priority Data
Apr. 20, 2020 (JP) 2020-074742

(51) Int. Cl. H01F 27/28; H01F 27/255

(52) U.S. Cl. CPC H01F 27/2823; H01F 27/255

(57) ABSTRACT

In a coil component, a stray capacitance may occur between a conducting wires of an upper layer and a conducting wires of a lower layer arranged in the vertical direction due to the potential difference between them. In the coil component, a separation distance between the conducting wire of the upper layer and the conducting wire of the lower layer is designed to be longer than twice a thickness of an insulation coating of a portion covering a side surface of the conducting wire, and a sufficiently long distance is secured, and thus the stray capacitance is reduced.

### CROSS-REFERENCE TO RELATED APPLICATIONS

This application is based upon and claims the benefit of priority from Japanese Patent Application No. 2020-74742, filed on 20 Apr. 2020, the entire contents of which are incorporated herein by reference.

### TECHNICAL FIELD

The present disclosure relates to a coil component.

### BACKGROUND

Regarding a coil component in the related art, for example, Japanese Unexamined Patent Publication No. 2010-245473 (Patent Literature 1) and Japanese Unexamined Patent Publication No. 2015-126201 (Patent Literature 2) disclose coil components including a coil in which one rectangular wire is wound in two layers.

### SUMMARY

The coil component having the above-described structure can be applied to a noise filter in a high frequency band of 30 MHz or more. High impedance is required to improve noise removal performance of a coil component in a high frequency band. As results of diligent research, the inventors have discovered a new technique for reducing a stray capacitance of a coil component in order to improve impedance.

According to the present disclosure, a coil component having a reduced stray capacitance is provided.

A coil component according to an aspect of the present disclosure includes a base body constituted of a metal magnetic powder-containing resin and having a pair of side surfaces, and a coil connecting between the pair of side surfaces inside the base body, the coil is constituted of a rectangular wire wound in two layers around a predetermined coil axis, the rectangular wire includes a conducting wire and an insulation coating covering a surface of the conducting wire, wherein a separation distance between the conducting wire of an upper layer and the conducting wire of a lower layer of the rectangular wire is longer than twice a thickness of the insulation coating in a portion covering a surface of the conducting wire parallel to the coil axis.

In the coil component, a stray capacitance generated between the conducting wire of the upper layer and the conducting wire of the lower layer of the rectangular wire is reduced by making the separation distance between the conducting wire of the upper layer and the conducting wire of the lower layer of the rectangular wire longer than twice the thickness of the insulation coating covering the surface of the conducting wire parallel to the coil axis.

In another type of coil component, a spacer interposed between the upper layer and the lower layer of the rectangular wire may be further provided.

In another type of coil component, a thickness of the insulation coating in a portion covering a lower surface of the conducting wire of the upper layer and a thickness of the insulation coating in a portion covering an upper surface of the conducting wire of the lower layer may be thicker than that of the insulation coating in a portion covering a surface of the conducting wire parallel to the coil axis.

### BRIEF DESCRIPTION OF THE DRAWINGS

FIG. 1 is a schematic perspective view of a coil component according to an embodiment.

FIG. 2 is a cross-sectional view along line II-II in the coil component shown in FIG. 1.

FIG. 3 is a perspective view of a coil of the coil component shown in FIG. 1.

FIG. 4 is an enlarged cross-sectional view of a main part in the coil shown in FIG. 3.

FIG. 5 is an enlarged cross-sectional view of a main part in the coil shown in FIG. 3.

FIG. 6 is a view showing a coil component of a different type.

### DETAILED DESCRIPTION

Hereinafter, an embodiment of the present disclosure will be described in detail with reference to the accompanying drawings. In the description, the same reference signs are used for the same elements or elements having the same function, and duplicate description will be omitted.

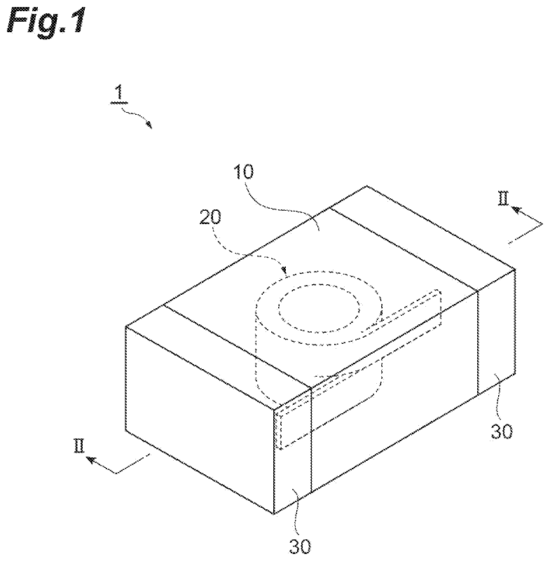

With reference to FIGS. 1 to 3, a structure of a coil component 1 according to the embodiment will be described. As shown in FIG. 1, the coil component 1 is configured to include a base body 10 which exhibits a rectangular parallelepiped shape, a coil 20 which is provided in the base body 10, and a pair of external terminal electrodes 30 which are provided on both outer surfaces of the base body 10. As an example, the coil component 1 is designed to have dimensions of a long side of 2.5 mm, a short side of 2.0 mm, and a height of 0.8 to 1.2 mm.

The base body 10 is constituted of a metal magnetic powder-containing resin. The metal magnetic powder-containing resin is a binding powdery substance in which a metal magnetic powdery substance is bound with a binder resin. A dielectric constant of the metal magnetic powder-containing resin constituting the base body 10 is, for example, 150.0 to 300.0 (195.0 as an example). For example, the metal magnetic powder of the metal magnetic powder-containing resin may be constituted of amorphous alloys such as an iron-nickel alloy (a Permalloy alloy), or carbonyl iron, a non-crystalline or crystalline FeSiCr-based alloy, Sendust, or the like. For example, the binder resin is a thermosetting epoxy resin. In the embodiment, a metal magnetic powdery substance content in the binding powdery substance may be 80 to 92 vol % in percent by volume and may be 95 to 99 wt % in percent by mass. From the viewpoint of magnetic characteristics, the metal magnetic powdery substance content in the binding powdery substance may be 85 to 92 vol % in percent by volume and may be 97 to 99 wt % in percent by mass. The magnetic powder of the metal magnetic powder-containing resin may be a powdery substance having an average particle size of one kind or may be a powder mix having an average particle size of a plurality of kinds.

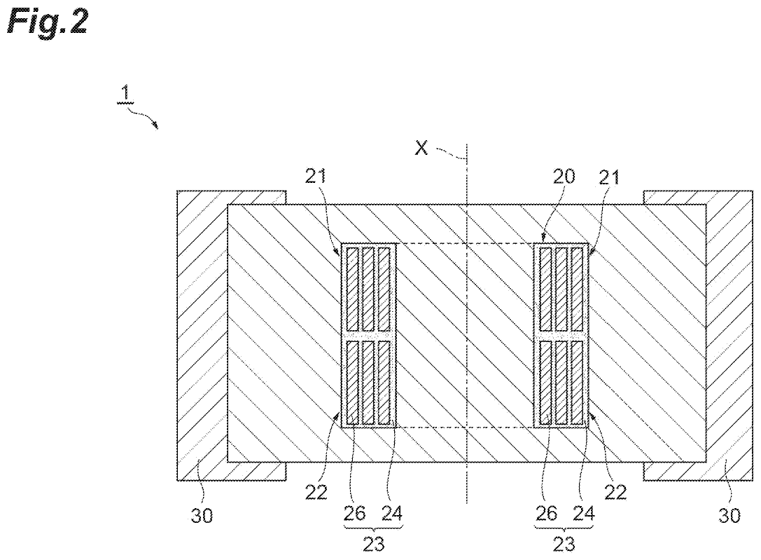

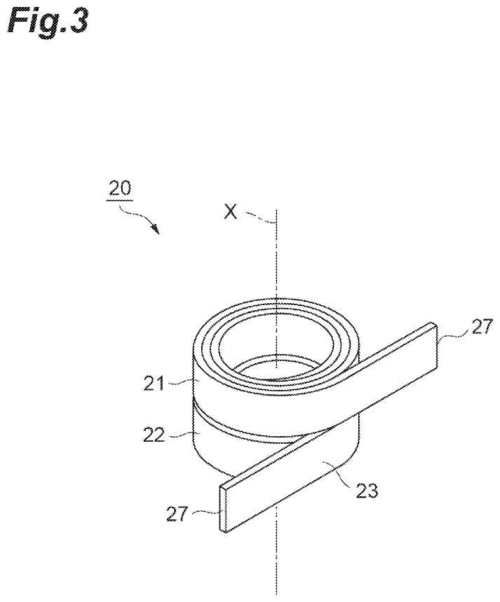

As shown in FIGS. 2 and 3, a coil 20 is an air-core coil having a two-layer structure including an upper layer 21 and a lower layer 22. More specifically, the coil 20 has a configuration in which the rectangular wire 23 is wound in an a-shape, and is wound around a coil axis X in the upper layer 21 and the lower layer 22. The rectangular wire 23 is configured to include an insulation coating 24 and a conducting wire 26 and has a configuration in which the entire surface of the rectangular conducting wire 26 is covered with the insulation coating 24. Both end portions 27 of the rectangular wire 23 extend from the same side surface of the coil 20 to both end surfaces of the base body 10. The dimensions of the rectangular wire 23 are, for example, a thickness T of 100 to 400 μm (250 μm as an example) and a width W of 20 to 250 μm (100 μm as an example).

The insulation coating 24 is constituted of a resin having insulating properties such as a polyimide resin, an epoxy resin, a phenol resin, or an acrylic resin. A relative dielectric constant of the insulation coating 24 is, for example, 3.0 to 5.0 (3.8 as an example). Before the conducting wire 26 is wound, the entire surface of the rectangular wire 23 except end portions of the conducting wire 26 which constitutes end portions of the rectangular wire 23 is coated with the insulation coating 24. The insulation coating 24 can be formed by, for example, dipping the conducting wire 26 into a liquid resin tank. The insulation coating 24 is not formed on the end portions 27 of the rectangular wire 23 allowing electrical conduction with respect to the external terminal electrode 30.

The pair of external terminal electrodes 30 are connected to both end portions 27 of the rectangular wire 23 exposed on each of the end surfaces of the base body 10.

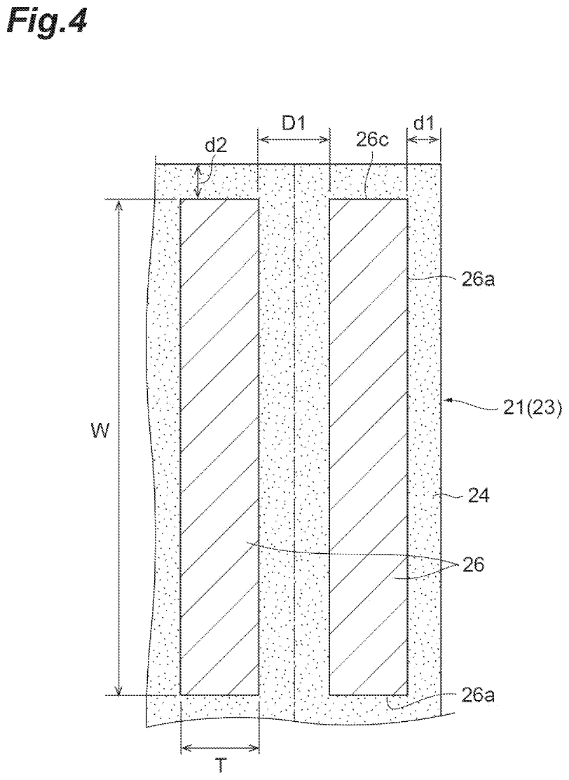

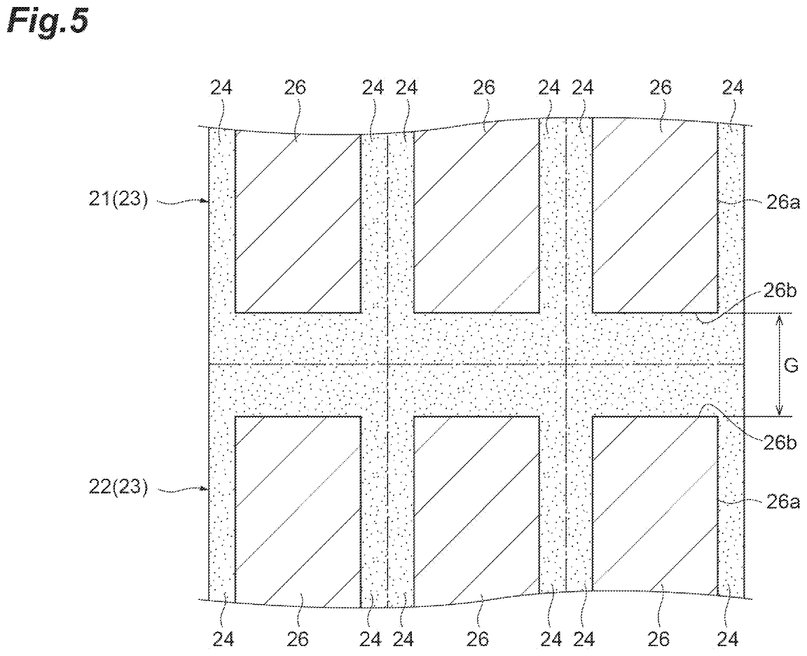

Here, a thickness of the insulation coating 24 of the rectangular wire 23 will be described with reference to FIGS. 4 and 5. FIG. 4 shows a cross section of the rectangular wire 23 in the upper layer 21. FIG. 5 shows a cross section of a region in which the rectangular wire 23 of the upper layer 21 and the rectangular wire 23 of the lower layer 22 overlap.

As shown in FIG. 4, the conducting wire 26 of the upper layer 21 includes a side surface 26a which is a surface parallel to the coil axis X, a facing surface 26b which is a surface facing the conducting wire 26 of the lower layer 22, and a non-facing surface 26c which is a surface located on the side opposite to the facing surface 26b. Like the conducting wire 26 of the upper layer 21, the conducting wire 26 of the lower layer 22 also includes a side surface 26a which is parallel to the coil axis X, a facing surface 26b which faces the conducting wire 26 of the upper layer 21, and a non-facing surface 26c which is located on the side opposite to the facing surface 26b.

In the present embodiment, in the upper layer 21 and the lower layer 22, a thickness d1 of the insulation coating 24 in a portion which covers the side surface 26a of the conducting wire 26 is, for example, 1 to 10 μm, and a thickness d2 of the insulation coating 24 in a portion which covers the non-facing surface 26c of the conducting wire 26 is, for example, 1 to 10 μm. The thickness d1 and the thickness d2 of the insulation coating 24 may be the same as or different from each other. For example, the thickness d2 of the insulation coating 24 may be thicker than the thickness d1 thereof.

In the cross section shown in FIG. 4, a thickness D1 of the insulation coating 24 between the adjacent conducting wires 26 may be twice as thick as the thickness d1. The thickness D1 of the insulation coating 24 may be thinner than twice the thickness d1 due to compressive stress generated between the adjacent conducting wires 26.

As shown in FIG. 5, the facing surface 26b of the conducting wire 26 of the upper layer 21 and the facing surface 26b of the conducting wire 26 of the lower layer 22 face each other, and the insulation coating 24 is interposed between the facing surfaces 26b facing each other. A separation distance G between the facing surfaces 26b facing each other in a vertical direction defines the thickness of the insulation coating 24 in the portion which covers the facing surfaces 26b of the conducting wire 26. The coil 20 is designed so that the separation distance G is longer than twice the thickness d1 of the insulation coating 24 in the portion which covers the side surface 26a of the conducting wire 26 (that is, G>2d). In the present embodiment, the separation distance G is, for example, 25 to 80 μm.

In the coil component 1, a stray capacitance may occur between the conducting wire 26 of the upper layer 21 and the conducting wire 26 of the lower layer 22 arranged in the vertical direction due to a potential difference therebetween. However, in the coil component 1, since the separation distance G between the conducting wire 26 of the upper layer 21 and the conducting wire 26 of the lower layer 22 is designed to be longer than twice the thickness d1 of the insulation coating 24 in the portion which covers the side surface 26a of the conducting wire 26, a sufficiently long distance is ensured, and thus the stray capacitance is reduced.

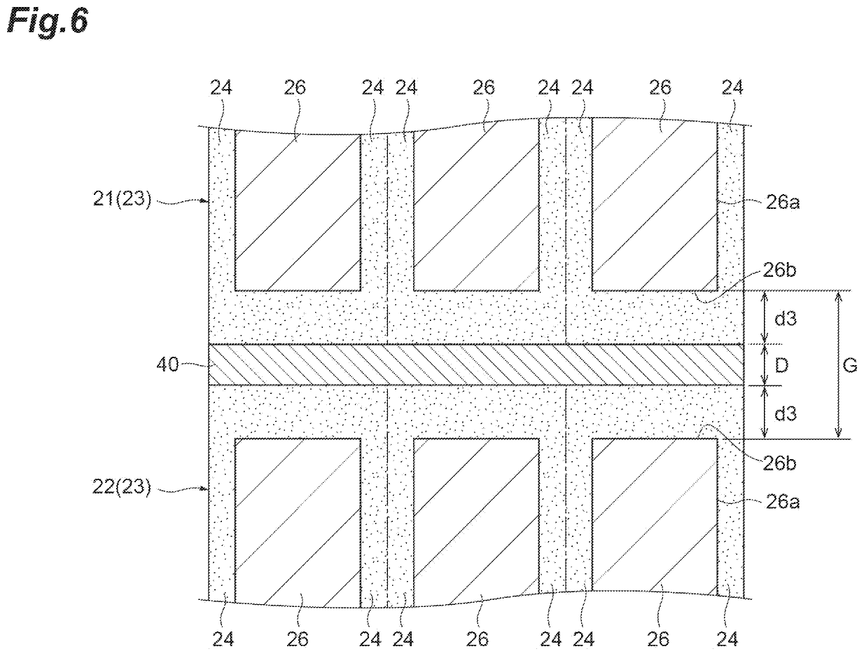

As shown in FIG. 6, the coil component 1 may have a spacer 40 interposed between the upper layer 21 and the lower layer 22 of the coil 20. The spacer 40 extends to be orthogonal to the coil axis X. The spacer 40 may be a film-like member interposed between the upper layer 21 and the lower layer 22 of the coil 20, and in this case, the spacer 40 may be constituted of an insulating material such as an adhesive, a conductive material such as metal powder, or a magnetic material such as a metal magnetic powder-containing resin. Further, the spacer 40 may be a depletion layer.

As the thickness D of the spacer 40 becomes thicker, the separation distance G between the conducting wire 26 of the upper layer 21 and the rectangular wire of the lower layer 22 becomes longer, and the stray capacitance is further reduced. A thickness d3 of the insulation coating 24 in a portion which covers the facing surface 26b of the conducting wire 26 may be designed to be thicker than the thickness d1 of the insulation coating 24 in the portion which covers the side surface 26a of the conducting wire 26 (d3>d1). In this case, even when a dielectric constant of the spacer 40 is relatively high, the stray capacitance can be sufficiently reduced.

The present disclosure is not limited to the above-described embodiment, and may take various aspects. For example, the conducting wire 26 of the upper layer 21 and the conducting wire 26 of the lower layer 22 may not be aligned to completely overlap each other in the vertical direction and may be misaligned.

What is claimed is:

1. A coil component comprising:
a base body constituted of a metal magnetic powder-containing resin and having a pair of side surfaces; and
a coil connecting between the pair of side surfaces inside the base body, the coil is constituted of a rectangular wire wound in two layers around a predetermined coil axis, the rectangular wire includes a conducting wire and an insulation coating covering a surface of the conducting wire,
wherein a separation distance between the conducting wire of an upper layer and the conducting wire of a lower layer of the rectangular wire is longer than twice a thickness of the insulation coating in a portion covering a surface of the conducting wire parallel to the coil axis.

2. The coil component according to claim 1, further comprising a spacer interposed between the upper layer and the lower layer of the rectangular wire.

3. The coil component according to claim 1, wherein a thickness of the insulation coating in a portion covering a lower surface of the conducting wire of the upper layer and a thickness of the insulation coating in a portion covering an upper surface of the conducting wire of the lower layer are thicker than that of the insulation coating in a portion covering a surface of the conducting wire parallel to the coil axis.
